(19) United States
(12) Patent Application Publication
(10) Pub. No.: US 2026/0179959 A1
(43) Pub. Date: Jun. 25, 2026

(54) LITHIUM-ION BATTERY HAVING BINDER-FREE ANODE

(71) Applicant: YAZAKI CORPORATION, Tokyo (JP)

(72) Inventors: Sean Imtiaz Brahim, Camarillo, CA (US); Stefan Maat, Camarillo, CA (US)

(21) Appl. No.: 19/543,705

(22) Filed: Feb. 18, 2026

Related U.S. Application Data
(63) Continuation of application No. PCT/US2024/044436, filed on Aug. 29, 2024.
(60) Provisional application No. 63/579,769, filed on Aug. 30, 2023.

(51) Int. Cl. H01M 4/62; H01M 4/04; H01M 4/36; H01M 4/505; H01M 4/525; H01M 4/587; H01M 4/66; H01M 10/0525

(52) U.S. Cl. CPC H01M 4/625; H01M 4/0404; H01M 4/0416; H01M 4/0435; H01M 4/364; H01M 4/505; H01M 4/525; H01M 4/587; H01M 4/623; H01M 4/661; H01M 10/0525

(57) ABSTRACT

The present invention relates to a lithium-ion battery (LiB) having a binder-free anode comprising an active material and about 1-5% by weight of single wall carbon nanotubes (SWCNT) as a conductive additive, wherein the SWCNT has an inorganic impurity content of less than 10% by weight. The LiB of the present invention having a binder-free anode, provides higher capacity than a LiB having an anode that contains a polymeric binder.

### CROSS-REFERENCE TO RELATED APPLICATION(S)

This application is a continuation of PCT/US2024/044436, filed Aug. 29, 2024; which claim priority to U.S. Provisional Application Nos. 63/579,769, filed Aug. 30, 2023. The above identified applications are incorporated herein by reference in their entireties.

### TECHNICAL FIELD

This invention relates to the use of high purity single wall carbon nanotubes (SWCNT) as a conductive additive in lithium-ion battery (LiB) anodes. The anodes further do not contain a polymeric binder and significantly improve performance characteristics of fully assembled LiB cells.

### BACKGROUND

Lithium-ion batteries (LiBs) are commonly used in consumer electronics, and are attractive for use in hybrid gas-electric and all-electric vehicles. However, improvements in battery performance are needed for widespread vehicle application. Specifically, increased energy density, power density, lighter weight, and better reliability are desirable. Particularly attractive are thinner and/or lighter electrode materials having lower electrical resistance, more efficient ion transfer capability, and sufficient mechanical strength for battery use.

Current LiBs have polymeric binder in their electrodes at various compositions, sometimes as high as 20 wt %. Cathodes typically employ a polymeric binder that is soluble in organic solvent, such as polyvinylidene difluoride (PVdF) in N-methyl pyrrolidone (NMP). Anodes utilize either similar organic-based binder as cathodes, or may be processed using an aqueous-based binder system such as styrene butadiene rubber (SBR) combined with carboxymethylcellulose (CMC) as a thickening agent. In both electrodes, the inclusion of polymeric electrically insulating binder results in high internal resistance, leading to long cell charge times and increased heat dissipation at a given charging current. Additionally, the binder present in LiB electrodes is an inactive component and does not contribute to cell capacity. The presence of this inactive component in LiB electrode formulations therefore restricts maximization of the active material content and limits LiB capacity.

Carbon nanotubes (CNT) are cylindrical graphitic nanostructures composed predominantly of sp² hybridized carbon atoms. CNT are classified according to the number of cylindrical graphitic sheets or “walls” that compose their individual nanotube structure. Nanotubes possessing one wall are referred to as single-wall carbon nanotubes (SWCNT), to differentiate them from those possessing two or more walls, called multi-wall carbon nanotubes (MWCNT). MWCNT with two walls are also called double-wall carbon nanotubes (DWCNT). Both types of CNT, SWCNT and MWCNT, possess nanometer-size diameters and micron-size lengths, offering high surface to volume ratio and giving rise to a high aspect ratio characteristic. Since the typical diameter of an individual SWCNT is 5-50 times smaller than the diameter of an individual MWCNT, SWCNT have significantly higher aspect ratio than MWCNT. SWCNT may be metallic or semiconducting depending on their structural arrangement. In the so-called armchair structure they are metallic, while in the zigzag or chiral structure they are semiconducting.

There is a need for new materials that can function as a binder in the anode of an LiB, but will not display the disadvantage of electrically insulating polymeric binder resulting in lower cell capacity and high internal cell resistance, in turn resulting in increased heat dissipation and long charge times.

### BRIEF DESCRIPTION OF THE DRAWINGS

In all the following figures, for both cathode and anode, “binder-free” means the electrode contains no (0%) polymeric binder, and the electrode contains 2% SWCNT.

In all the following figures, for both cathodes and anodes, “binder-containing” or “with binder” means the electrode contains 3-5% polymeric binder such as PVdF, and no (0%) CNT.

FIG. 1 shows comparison of fabrication of anode coatings using conventional additives of binder and conductive carbon versus SWCNT.

FIG. 2 shows a process flow diagram of LiB anode preparation method.

FIG. 3 shows the comparison of impedance of LiB pouch cells assembled with binder in both electrodes, binder-free anode with as-received (10.5% Fe) SWCNT paired with binder-containing cathode, binder-free anode with high-purity (<1% Fe) SWCNT paired with binder-containing cathode, and binder-free cathode and binder-free anode electrodes both with high-purity SWCNT. Active cathode material is NMC111 and active anode material is graphite, in all cells.

FIG. 4 shows charge-discharge profiles of four LiB cells after 10 cycles between 3 V and 4.2 V at 10 C discharge rate: Cell with binder in both anode and cathode (dashed line), Cell with binder-free anode using as-received (10.5% Fe) SWCNT and binder-containing cathode (solid gray line), Cell with binder-free anode using high-purity (<1% Fe) SWCNT and binder-containing cathode (dotted line), and a completely binder-free cell (solid black line).

FIG. 5 shows charge-discharge profiles of LiB cell containing binder-free Si-doped graphite anode+NMC cathode with PVdF binder (solid line), and cell with binder in both anode and cathode (broken line), after 10 cycles between 3 V and 4.2 V at 10 C discharge rate.

FIG. 6 shows formation cycles at 0.1 C rate of LiB pouch cell containing binder-free C-LTO anode paired with NMC cathode (with binder).

FIG. 7 show the comparison of cell DC impedance values of LiB pouch cells assembled with binder containing C-LTO|NMC electrodes and binder-free C-LTO|NMC electrodes.

FIG. 8 shows the 1 C charge-10 C discharge profiles of LiB cells containing binder-free C-LTO anode (right), and cell with binder in the C-LTO anode (left) after 10 cycles between 1.5 V to 2.8 V.

FIG. 9 shows the comparison of normalized cell capacities of LiB pouch cells assembled with binder containing C-LTO|NMC electrodes and binder-free C-LTO paired with binder containing NMC electrodes at two investigated C-rates.

FIG. 10 shows the comparison of lifetime cycling of LiB pouch cells assembled with binder containing and binder-free (bf) LTO|NMC electrodes.

### DETAILED DESCRIPTION

The inventors have discovered that the use of high purity, well-dispersed conductive single wall carbon nanotubes (SWCNTs) as conductive additive material to anode formulations of lithium-ion batteries (LiBs) provides enhanced performance characteristics in the fully assembled cell, and obviates the need for an inactive binder. In current commercial LiBs, a conductive additive such as carbon black is included in LiB anode formulations to lower the overall electrode resistance. The high aspect ratio of the carbon nanotubes, in particular SWCNT, in contrast to conventional carbon black particles, provides good contact between active graphite flakes or other particulate anode materials as described below, and allows conductive percolation at lower incorporated levels.

LiB cells typically comprise an anode, a cathode, and an electrolyte comprising a lithium salt in an organic solvent.

The present invention is directed to anodes in LiB cells. The anode comprises an active material and about 0.1-10% by weight (wt %) of single wall carbon nanotubes (SWCNT) as a conductive additive, wherein the SWCNTs have an inorganic impurity content of <10 wt %, preferably <3 wt %, more preferably <2 wt %, or <1 wt %.

As used in this application, “about” refers to +10% of the recited value.

Unless specified otherwise, % in this application refers to % by weight (wt %).

The present invention relates to a LiB. The active material of the LiB anode of the present invention typically contains a material selected from the group consisting of: graphite, silicon (Si)-doped graphite, Si alloy, Si particles in the form of nano- or micro-particles, lithium titanate (LTO) such as Li₄Ti₅O₁₂, niobium-doped LTO such as Titanium Niobium Oxide (TNO), and any combination thereof. The LiB anode of the present invention typically contains 90-99 wt % of active material, preferably 95-98 wt %.

The graphite used as anode active material in binder-free electrodes can be either natural or synthetic grade, including expanded graphitic forms, with D₅₀ flake sizes ranging from 1 μm to 1 mm, preferably 5 μm to 50 μm, and more preferably 9 μm to 25 μm. Graphite purity is key to battery anode performance. For binder-free graphitic anodes, carbon purity levels >90% are preferred, and purity levels of 99.9% or higher are more preferred.

When Si-doped graphite is an active material, the Si content in the anode may range between 0.5 and 99.5 wt %, preferably between 5 and 60 wt %, and more preferably between 10 and 40 wt %.

When LTO is an anode active material, a preferred crystal structure is spinel Li₄Ti₅O₁₂, but variations of Li₄₊ₓTi₅O₁₂ structures where x=0 to 3 can also function as the active material. For example, Li₇Ti₅O₁₂ in the rock salt crystal structure can function as anode active material.

When LTO is an active material, LTO may be in a form of nanoparticles. The LTO nanoparticles preferably have a carbon coating.

In one embodiment, the anode electrode further comprises a copper current collector. The copper current collector may comprise copper foil and a carbon primer layer deposited onto the copper foil. In one embodiment, the copper current collector comprises corona plasma discharge-treated copper foil.

In another embodiment, the anode electrode further comprises an aluminum current collector. The aluminum current collector may comprise aluminum foil and optionally, a carbon primer layer deposited onto the aluminum foil. In one embodiment, the aluminum current collector comprises corona plasma discharge-treated aluminum foil.

In a preferred embodiment, the LiB anode is essentially free of a polymeric binder such as polyvinylidene difluoride (PVdF) or styrene butadiene rubber (SBR). “Essentially free of”, as used herein, means containing <5 wt %, or <3 wt %, or <1 wt %, or preferably 0 wt %.

In the present LiB anodes, carbon nanotubes act as both a conductive additive and a binder to connect and hold the active material particles together. As such, they effectively replace both the conductive carbon black additive and polymeric binder that are typically used in current commercial LiBs.

In describing the present invention, it is important to note the distinction between anode electrode and cathode electrode. In LiBs, the materials typically used as the active component in the anode, are different than the materials typically used as the active component in the cathode. For example, LiB anodes may comprise graphite, silicon, or silicon-graphite composite. LiB cathodes, on the other hand, typically comprise a layered oxide (such as lithium cobalt oxide, LCO), a polyanion (such as lithium iron phosphate, LFO), or a spinel (such as lithium manganese oxide, LMO). LiB anode materials such as graphite or silicon have different morphologies, crystal structures, and bonding behavior than typical LiB cathode materials.

Furthermore, the volume expansion of certain anode materials during cell cycling is significantly different than that of cathode materials, and can be much greater, for example, when silicon is present in the active anode material. Because of the differences in materials and behavior between active cathode and active anode materials, the anode active materials and the cathode active materials may interact with CNT differently.

The present invention uses SWCNT, rather than MWCNT, as a high-aspect ratio conductive additive material to anode formulations of LiBs to enhance the performance characteristics of the fully assembled LiB cell. The advantages of using SWCNT over MWCNT as a conductive additive material in LiB anode formulations are due to the relatively higher aspect ratio and higher surface area afforded by SWCNT. SWCNT typically have 5-50 times higher aspect ratio than MWCNT. SWCNT typically also have several hundred to more than one thousand m²/g higher surface area than MWCNT. This combination of higher aspect ratio and higher surface area of SWCNT compared to MWCNT make SWCNT more attractive than MWCNT for use in the present invention as a conductive carbon additive.

The amount of SWCNT in the binder-free anode formulation of the present invention is in the range of 0.1-10 wt %, preferably 0.5-5 wt %, and more preferably 1-5 wt % or 1-3 wt %. The SWCNT acts to connect the active material such that no binder material is required in the electrode, which allows a higher weight percent of active material than in LiB anodes containing conventional polymeric binder. In one embodiment, binder-free anodes of the present invention comprise 2 wt % SWCNT and 98 wt % LTO. Conventional anodes using LTO as an active material typically contain 90 wt % LTO and a polymeric binder.

In one embodiment, the LiB anode comprises SWCNT as the only conductive additive, and it does not comprise a substantial amount of other conductive additive such as carbon black. For example, the anode does not comprise more than 0.1% by weight of carbon black or does not comprise any carbon black.

The inventors have discovered that the use of high purity and well-dispersed conductive carbon nanotubes, in particular single wall carbon nanotubes (SWCNT), as a conductive additive material to anode formulations of Li ion batteries enhances the performance characteristics of the fully assembled LiB cell, and removes the need for polymeric binders. The high aspect ratio of the carbon nanotubes, in contrast to conventional carbon black particles, provides good contact between active material and allows conductive percolation at lower incorporated levels. The inventors discovered that to achieve the desired performance enhancement, the SWCNT should be of high purity with <10 wt % inorganic impurities, preferably <3 wt %, more preferably <2 wt %, and even more preferably <1 wt % inorganic impurity. As a comparison, commercial SWCNT typically contains more than 10% (e.g., 10-25%) inorganic impurities by weight including, but not limited to iron (Fe), nickel (Ni), silicon (Si), aluminum (Al), and chlorine (Cl). These impurities are usually present as residues of manufacturing or purification processes.

The SWCNT should possess a BET specific surface area of between about 400 and about 1300 m²/g, preferably between about 800 and about 1300 m²/g, and should be highly graphitized, that is, composed predominantly of sp² hybridized carbon atoms, with minimal tube defects, as evidenced by a Raman G/D ratio of at least 20, preferably at least 40, or more preferably at least 60, as measured using a laser with a wavelength of 532 nm.

The SWCNT in the present invention can be metallic SWCNT, semiconducting SWCNT, or a mixture of metallic and semiconducting SWCNT. In aggregate, this mixture of high aspect ratio, high purity metallic and semiconducting SWCNT has a relatively high electrical conductivity. The incorporation of conductive SWCNT with these specific criteria to anode formulations of LiB cells provides the necessary performance gains of increased rate capability and reduced impedance to enable next generation battery systems.

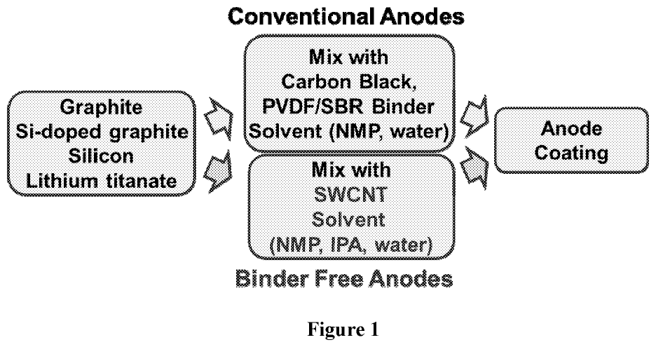

FIG. 1 shows a pathway to fabrication of binder-free anode coatings using high-purity SWCNT as replacement for conventional binders and conductive carbon.

The present invention uses purified SWCNT to replace conventional conductive additives such as carbon black in the anode of LiB cells. One of the challenges faced with processing high aspect ratio SWCNT into solution is overcoming the substantial van der Waals interaction in order to achieve a stable dispersion of SWCNT. The common approach is to utilize a suitable dispersant or surfactant to minimize agglomeration and re-bundling of the nanotubes after processing in solution. For example, U.S. Pat. No. 9,543,054 describes a method of fabricating binder-free anodes for lithium-ion batteries by suspending SWCNT in 1% sodium dodecyl sulfate (SDS) surfactant solution followed by sonication for 15 minutes before vacuum filtration. However, the presence of SDS adversely impacts inherent SWCNT properties such as high electrical conductivity, and it adds additional post-processing time and cost for removing the SDS from the processed SWCNT.

The present invention provides a method for processing high aspect ratio, purified SWCNT into a stable dispersion by using a mechanical process without using a dispersant or surfactant. Aggregates and large bundles of SWCNT are sufficiently reduced in size by high shear processing, such that they remain suspended and dispersed in the carrier solvent over long periods without separating or settling. The mechanically processed SWCNT dispersion is stable in that the dispersed nanotubes are not observed to agglomerate nor show any sedimentation after standing for at least 24 hours, or for at least several weeks at room temperature.

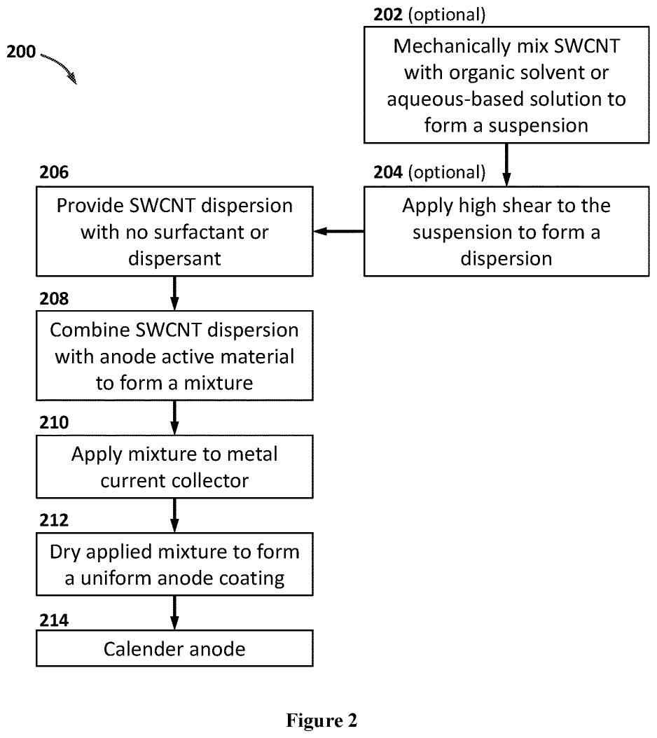

The present invention provides a method 200 of preparing binder-free LiB anodes, an exemplary embodiment of which is illustrated in FIG. 2. In step 206, a SWCNT dispersion is provided. The SWCNT in the dispersion has an inorganic impurity content (Fe, Ni, Al, Si, Cl) of less than 10 wt %, and the SWCNT dispersion does not contain a surfactant or a dispersant. In step 208, the SWCNT dispersion is combined with an anode active material in a prescribed ratio to form a homogeneous mixture. This is typically accomplished using a standard mixing and formulating equipment (e.g., planetary mixer, high shear mixer, sonicator). In step 210, the homogeneous mixture is applied to a metal plate or foil which acts as a current collector. The current collector is typically battery-grade copper or aluminum foil. The current collector optionally is etched on one or both surfaces or has a carbon primer coating on one or both surfaces to improve adhesion of the anode material. The homogeneous mixture is applied to the current collector using conventional coating techniques such as, but not limited to, doctor blade (knife-coating), Mayer rod coating, slot-die coating, and reverse comma coating. In step 212, the homogeneous mixture applied to the foil is then dried to form a uniform anode coating on the current collector. After drying, in step 214 the anode comprising the anode active material coating deposited on the current collector is calendered using, for example, standard calendering or rolling equipment. After the calendering step, the anode coating exhibits no sign of flaking off or delamination from the current collector, or transfer of material to the calendering rolls or other contacted surface.

Optionally, the SWCNT dispersion provided in step 206 is first formed via a two-step process. In step 202, SWCNT with <10 wt % inorganic impurities are mechanically mixed with an organic solvent or aqueous-based solution or a mixture thereof, without a surfactant or dispersant, to form a suspension. Typical organic solvents include, but are not limited to, isopropyl alcohol (IPA), N-methyl 2-pyrrolidone (NMP), tetrahydrofuran (THF), dimethyl sulfoxide (DMSO), dimethyl formamide (DMF), benzene, ortho-dichlorobenzene (ODCB), propanol, and ethanol. In step 204, the SWCNT in the suspension are debundled by applying shear to the suspension at a shear rate of at least 800,000 s⁻¹ to form a stable dispersion of SWCNT. In one embodiment, the shear is applied by passing the suspension under high pressure through at least one channel with a cross-section of 300 m or less. The stable SWCNT dispersion is then used in subsequent steps 206-214 as described above.

Typical SWCNT loading in the dispersion ranges from 1 g/L to 100 g/L, more preferably 5 g/L to 80 g/L, and most preferably 10 g/L to 50 g/L. Viscosity of the SWCNT-based dispersions are dependent on the SWCNT loading, with viscosity ranging from 10,000-1,000,000 cP measured at a shear rate of 0.1 s⁻¹. Typically, the SWCNT dispersion is stable for at least 24 hours at room temperature without separation or sedimentation.

In one embodiment, binder-free LTO active material with SWCNT additive is coated onto a battery-grade aluminum current collector (with or without carbon layer), using any standard coating technique such as those listed above.

Typically, the dry thickness of the active anode layer ranges from 40 to 120 μm. In one embodiment, the thickness of the anode is 100-120 μm. In another embodiment, the thickness of the anode is 55-65 μm.

LiB cells are subsequently assembled, using active cathode material paired with binder-free active anode electrodes. As mentioned above, the active materials of an anode and a cathode in a LiB cell are different and they have different morphologies, crystal structure, and bonding behaviors. Also, the volume expansion of anode active materials during cell cycling is different from that of cathode active materials. Examples of active cathode materials include, but are not limited to, Li—NiMnCo—Oxide (NMC), Li—NiCoAl—Oxide (NCA), Li—Fe-Phosphate (LFP), Li-Cobalt-Oxide (LCO), Li-Manganese-Oxide (LMO), and any combination thereof. The LiB cell of the present invention having a binder-free anode, exhibits specific performance improvements over a conventional LiB cell containing polymeric binder in the anode.

In one embodiment, the binder-free graphitic anode described in this disclosure is combined with a binder-free NMC 111 cathode to assemble a fully binder-free LiB pouch cell. In this embodiment, the battery performance is further improved through increased capacity and reduced impedance. For example, the elimination of binder from both electrodes results in LiB cells possessing very low impedance of 0.5 mΩ/cm³, or a 37% reduction in impedance compared to a conventional LiB cell having the same cathode and anode active materials, but with polymeric binder. The cells assembled without binder in both anode and cathode electrodes exhibit a high measured specific capacity of 425 mAh/g after 10 consecutive 1 C charge-10 C discharge cycles (corresponding to 43 mAh/g in Table 6). This is more than 2-fold higher specific capacity compared to the conventional LiB cell with a polymer binder, which shows specific capacity of 210 mAh/g under the same high C-rate testing (corresponding to 20 mAh/g in Table 6). This demonstrates the superior high-rate capability of the binder-free cell.

Because neither a dispersant nor a surfactant is used to prepare the SWCNT dispersion, the anode material composition of the present invention is completely free of these substances, for example 1% SDS. The elimination of these substances from the SWCNT dispersion process ensures that they are not present in the anode material, and therefore, do not cause any such performance losses when the anode material is used in an assembled LiB cell.

Addition of high-purity SWCNT to the anode formulation of LiB cells in described quantities eliminates inactive material and provides improved performance such as increased cell capacity with simultaneously lower cell impedance, compared to LiB cells using conventional binder and carbon black conductive additive. In particular, the capacity gain over conventional LiB cells with binder-containing electrodes is maximized when the LiB cell is subjected to high-rate charge and discharge current conditions. Cells with polymeric binder in their electrodes have higher cell impedance and thus exhibit relatively higher dissipative heating at given charging or discharging currents. Therefore, relatively less energy ends up stored in such cells for the same charge time and current.

These significant performance gains are achieved at lower overall conductive additive content than for cells with standard carbon black additive, thus allowing increased active material levels in the electrode formulation with the potential to further increase the LiB cell capacity. Elimination of polymeric binder from the anode allows the assembly of LiB cells that are completely binder-free, when the binder-free anode is combined with a binder-free cathode.

Moreover, such significant gains in LiB performance appear to be specific and dependent on the purified SWCNT and cannot be achieved by incorporating as-received or unpurified SWCNT that contains >10% inorganic impurity (e.g., Fe, Ni, Al, Si, Cl), as an additive to the electrode.

As-received SWCNT often contains between 10% and 25% inorganic impurities and varying amounts of amorphous carbon. Incorporation of as-received, lower purity SWCNT with Fe amount greater than −10%, or even greater than ˜5%, into the LiB anode in similar quantity as a high-purity SWCNT yields LiB cells with lower performance, typically >7% higher cell impedance and >15% reduced capacity at high discharge rates compared to LiB cells with the same quantity of high-purity SWCNT.

The lifetime performance of such binder-free LiB cells using high-purity SWCNT additive is not compromised as shown in long-term (e.g., 1000-cycle) cycling tests, compared with cells having binder in the anode. In fact, improvements in percent capacity retention are provided in certain LiB cathode/anode configurations, by the elimination of binder in the anode combined with the use of high-purity SWCNT additive.

In some embodiments of the present invention, the lifetime performance of an LiB cell with a binder-free anode and high-purity SWCNT additive, is actually superior to that of an LiB cell having the same anode and cathode active materials, but with polymeric binder in the anode and no SWCNT additive. This advantage in lifetime performance is independent of whether the cathode contains binder or is binder-free. In one embodiment, the cathode active material is Li—NiMnCo-Oxide (NMC 111), and the anode active material is lithium titanate (LTO). For LiB cells with this particular combination of cathode and anode materials, the addition of high-purity SWCNT and removal of binder from the anode results in a clear improvement in capacity retention compared with cells having binder in the anode and no SWCNT. For example, NMC|LTO LiB cells with a binder-free, high purity SWCNT-containing anode retain nearly 100% of their initial capacity over 800 cycles between 1.5 and 2.8V, at 0.5 C rate, whereas NMC|LTO LiB cells containing binder in the anode and no SWCNT showed only 70-90% capacity retention under the same conditions. The invention is illustrated further by the following examples that are not to be construed as limiting the invention in scope to the specific procedures or products described therein.

### EXAMPLES

In all the following examples, for both cathodes and anodes, “binder-free” means the electrode contains no (0%) polymeric binder (such as PVdF), and the electrode contains 2% SWCNT.

In all the following examples, for both cathodes and anodes, “binder-containing” or “with binder” means the electrode contains 3-5% polymeric binder such as PVdF, and no (0%) CNT.

In all the following examples, unless specified “as received”, SWCNT means high purity (<1% impurity) SWCNT.

### 1. Preparation of SWCNT Dispersions—IPA- and Water-Based

Highly purified SWCNT (with ≤1 wt % inorganic impurities of Fe, Ni, and Si) were used to prepare dispersions of SWCNT in IPA and water. 20 g of SWCNT were impeller-mixed into 500 mL of IPA to produce 40 g/L SWCNT/IPA suspension. The suspension was subsequently processed through a high shear processor for 10 minutes at a shear rate of up to 800,000 s⁻¹ to obtain a 40 g/L dispersion of SWCNT in IPA with a viscosity of 1,000,000 cP measured at a shear rate of 0.1 s⁻¹. The process was repeated using water as dispersing medium to prepare a 40 g/L dispersion of SWCNT in water with viscosity of 800,000 cP measured at a shear rate of 0.1 s⁻¹. The resulting high-concentration dispersions had the consistency of a semi-solid paste after ten minutes of processing, and were stable for at least 24 hours at room temperature without separation or sedimentation.

The SWCNT dispersions prepared in this Example were then used in subsequent Examples for preparing LiB anode formulations.

### 2. Surface Treatment of Carbon-Primed Cu Current Collector

The surface tension of the anode slurries is typically much higher than the surface energy of the untreated Cu foil. Because of this energy mismatch, wettability and coating adhesion might be deficient, making it difficult to achieve an anode coating with uniform characteristics and possessing minimal defects. This is especially true in the coating of aqueous-based slurries onto current collectors, primarily due to the high surface tension of water (72.8 mN/m). Corona plasma treatment is a common technique for improving wetting and adhesion characteristics for polyolefin films by introducing polar groups on the surface, e.g., ROOH, RO₂R, where R represents the rest of the molecule. This treatment is expected to increase the surface energy of the Cu current collector.

To improve the wettability and coating of the anode slurries onto the Carbon-primed Cu current collector, a corona plasma discharge treatment was performed on the surface of the Cu foil. A roll of carbon-primed Cu foil (˜1000 m) was subjected to an in-line corona discharge treatment (CDT) using an energy density of ˜0.5 J/cm² for 4 hours. The corona-treated foil was then used for preparing anode samples as described in Examples below.

### 3. Binder-Free Graphitic Anode Formulations Using SWCNT Dispersion

Table 1 shows two binder-free anode formulations prepared in this Example. Each formulation was composed of 98 wt % graphite active material combined with 2 wt % SWCNT with no binder or carbon black component. One formulation was processed in IPA and the other in water.

To prepare the binder-free anode formulations, high purity SWCNT dispersions prepared as in Example 1 were mixed with a target quantity of graphite (162 nm crystallite size, 2.07 m²/g BET surface area) using a planetary mixer, and this anode mixture was then diluted with respective solvent (IPA or water, see Table 1) to a final solids content of about 40 wt %. Mixing was continued overnight in a planetary mixer at low speed. The final binder-free anode formulation was in the form of a slurry.

TABLE 1
Formulation matrix for binder-free anodes in IPA and water. CDT =
corona discharge treated; CB = Carbon Black; CNT = high purity SWCNT.

| | | | | | Active | Conductive | | |
|---|---|---|---|---|---|---|---|---|
| Formulation | Formulation | Coating | | Active | Material | Carbon % | | Binder |
| # | Solvent | Method | Foil type | Material | % | CB | CNT | % |
| 1 | IPA | Slot Die | CDT | Graphite | 98 | 0 | 2 | 0 |
| | | | C-coated Cu | | | | | |
| 2 | Water | Slot Die | CDT | Graphite | 98 | 0 | 2 | 0 |
| | | | C-coated Cu | | | | | |

### 4. Binder-Free Graphitic Anode Coatings

Both water-based and IPA-based binder-free graphitic anode formulations prepared in Example 3 were separately coated onto corona discharge treated (CDT) Cu foil using a slot-die coater.

The IPA-based anode mix exited the slot-die coater as a uniform slurry with good wetting and coating behavior onto the Cu foil. The dried coating exhibited no signs of flaking off or delamination from the foil. Approximately 20 meters of foil were coated with the IPA-based binder-free anode formulation. The dried anode coating was calendered and electrodes were punched and stacked with previously-prepared binder-containing and binder-free cathodes (NMC111, BASF), using an automated puncher and stacker. Five LiB pouch cells were assembled with binder-free anodes paired with binder-containing cathodes and paired with binder-free cathodes.

5. Performance of LiBs with Binder-Free Graphitic Anodes, and Low- or High-Purity SWCNT

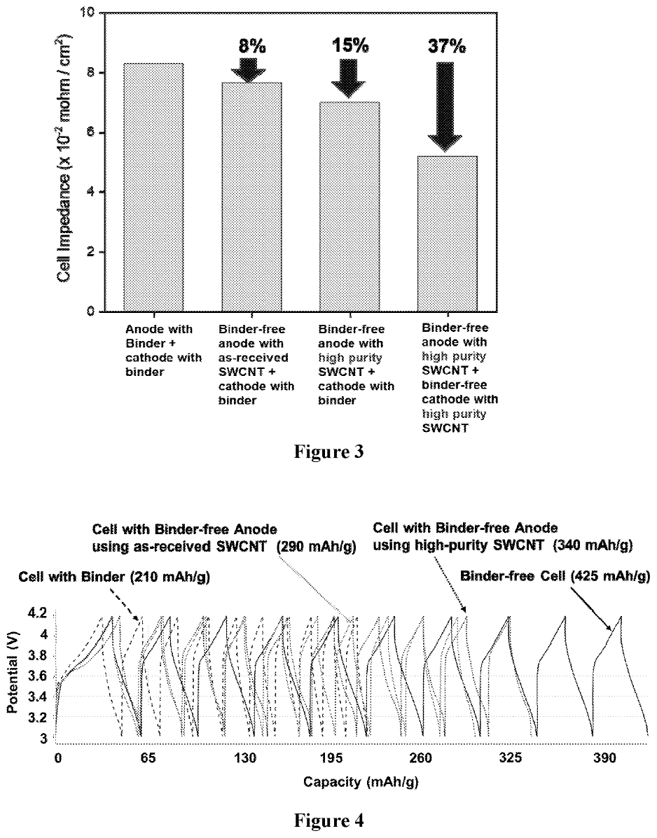

LiB pouch cells assembled in Example 4, containing binder-free graphitic anodes paired with binder-containing NMC111 cathodes, and with binder-free NMC111 cathodes, were checked for initial cell impedance measurement. For performance comparison, binder-free graphitic anodes containing 2 wt % as-received, lower purity SWCNT, and graphitic anodes containing carboxymethylcellulose/styrene butadiene rubber (CMC/SBR) binder and carbon black conductive additive were also fabricated and assembled into LiB cells. FIG. 3 compares the measured cell impedance of LiB pouch cells assembled (a) with binder, (b) with binder-free anode containing as-received, lower purity (˜10.5% Fe) SWCNT paired with binder-containing cathode, (c) with binder-free anode containing high-purity (<1% Fe) SWCNT paired with binder-containing cathode, and (d) with binder-free cathode and anode containing high-purity SWCNT. As shown, eliminating the binder from the anode lowers the cell impedance. However, the magnitude of the impedance reduction is dependent on the SWCNT purity. Using high-purity SWCNT in the anode results in a 15% reduction in cell impedance compared to the cell with binder (no SWCNT), whereas only 8% reduction in cell impedance is achieved when using as-received, lower purity SWCNT in the anode. The high-purity SWCNT in the anode provides about 2× greater reduction in cell impedance compared to as-received, lower purity SWCNT. The completely binder-free cell exhibits the lowest impedance of 5.2×10⁻² mΩ/cm², or a 37% reduction in impedance compared to the cell with binder (8.3×10⁻² mΩ/cm²).

6. High-Rate Performance of LiBs with Binder-Free Graphitic Anodes

### (i) Capacity

LiB pouch cells containing binder-free graphitic anodes paired with binder-free NMC111 cathodes, prepared as in Example 4, were tested for fast discharge rate performance at 1° C. After charging each cell to 100% capacity in 1 hour at 1 C, the cell was fully discharged in 6 minutes at 10 C. FIG. 4 shows the cumulative 1 C charge-10 C discharge profiles of the binder-free LiB cell type after 10 cycles between 3 V and 4.2 V. For benchmarking, the corresponding high-rate discharge profile for a LiB cell with polymeric binder in both electrodes, and for cells assembled with binder-free anodes using as-received, lower purity (10.5% Fe) SWCNT and high-purity (<1% Fe) SWCNT paired with binder-containing cathode are also shown in FIG. 4.

The charge-discharge profiles show that after 10 consecutive 1 C charge/10 C discharge cycles, the maximum capacity of ˜425 mAh/g was achieved with the LiB cell containing a binder-free graphite anode and a binder-free NMC cathode (corresponding to 43 mAh/g in Table 6) using high purity (<1% Fe) SWCNT. For reference, a conventional LiB pouch cell assembled with binder-containing graphite anode and binder-containing NMC cathode exhibited a cumulative capacity of ˜210 mAh/g after testing under the same charge/discharge rates (corresponding to 20 mAh/g in Table 6). The cell assembled with a binder-free anode using high-purity SWCNT paired with a binder-containing cathode exhibited a capacity of ˜340 mAh/g under the same high-rate testing compared to the cell with binder in both electrodes (corresponding to 40 mAh/g in Table 6). For comparison, and to illustrate the significance of SWCNT purity, the cell assembled with a binder-free anode using as-received SWCNT paired with a binder-containing cathode exhibited only a capacity of ˜290 mAh/g (corresponding to 35 mAh/g in Table 6A), under the same high-rate testing compared to the cell with binder in both electrodes. Clearly, the use of high-purity SWCNT in the binder-free anode results in advantageous LiB performance enhancement over as-received SWCNT.

Table 2 shows the cumulative capacities after 10 consecutive 1 C charge-10 C discharge cycles after normalizing to each LiB cell's respective mass.

TABLE 2
Cumulative specific capacities at 10 C rate of binder-
free LiB cells and the performance gain compared
to a LiB cell with binder-containing electrodes.

| | Capacity at | |
|---|---|---|
| Cell Type | 20 A (mAh/g) | % Gain in Capacity |
| Anode and cathode with | 210 | — |
| binder and without SWCNT | | |
| Binder-free anode and | 425 | 102 |
| cathode with high purity | | |
| SWCNT (Ex. 4) | | |

Compared to the cell with binder, LiB cells assembled without binder in the electrodes exhibited the highest measured specific capacity for graphitic anodes of 425 mAh/g (corresponding to 43 mAh/g in Table 6). This represents more than 2× higher specific capacity after high discharge rate testing compared to the cell with binder. The capacity gain is >100% relative to the capacity of the cell with binder. These results show the clear performance advantage of eliminating the polymeric binder from battery electrodes in high-rate applications.

### (ii) Lifetime Performance

Each assembled LiB pouch cell from above completed 1,000 consecutive charge-discharge cycles at 25° C. over the voltage range of 4.2 V-3.0 V, using constant current (CC) process at a rate of 0.5 C, with no rest period between charge and discharge steps. Both the cell with binder and binder-free cell exhibited similar rates of capacity fade with no significant difference in lifetime cycling performance after 1,000 cycles, confirming that the long-term cell performance is not compromised by elimination of the polymeric binders from both anode and cathode electrodes.

7. Binder-Free Si-Doped Graphite Anode Formulations with SWCNT Additive

An anode formulation in IPA was prepared from commercial Si powder (1-4 μm), high-purity battery grade natural graphite (162 nm crystallite size, 2.07 m²/g BET surface area), and SWCNT in the quantities shown in Table 3. The graphitic slurry was doped with a loading of 30 wt % silicon powder. The mixture of 70 wt % graphite and 30 wt % Si powder was processed into an anode formulation using SWCNT as conductive binder additive at 2 wt %.

TABLE 3
Respective mass loadings of anode materials
per 1 L of IPA dispersing solvent.

| Component | Amount, g (per 1 L IPA) |
|---|---|
| Si powder | 176.4 |
| Graphite | 411.6 |
| SWCNT | 12 |

Si particles are known to readily agglomerate, therefore, to minimize this effect, Si was processed along with SWCNT powder in IPA solvent via high shear treatment. 12 g of SWCNT and 176.4 g of Si powder were mixed into 1000 mL of IPA by impeller mixing. The mixture was subsequently processed through a high shear processor at up to 800,000 s⁻¹. The resulting composite slurry of SWCNT/Si in IPA had the consistency of a semi-solid paste.

In the second processing step, graphite active material (411.6 g) was added to the SWCNT/Si slurry and mixed using a planetary mixer. An additional 150 mL of IPA solvent was added to the slurry to adjust the solids content to 52 wt %, to produce a slurry with suitable consistency for knife coating.

### 8. Binder-Free Si-Doped Graphite Anode Coatings

The binder-free Si-doped graphite anode formulation prepared in Example 7 was coated onto carbon-primed Cu foil via knife-coating. The binder-free formulation was found to wet and spread evenly across the foil surface. The knife gap was set at 0.55 mm, which resulted in a loading of 6.5 mg/cm² per side consisting of 98% active material. The average dry anode coating thickness was 45 μm per side fabricated using these parameters. All resulting dried anode coatings appeared smooth without the visible presence of coarse agglomerates, fractures, or pinholes.

### 9. LiB Pouch Cell Containing Binder-Free Si-Doped Graphite Anode

The binder-free Si-doped graphitic anode sheets prepared in Example 8 were assembled into LiB pouch cells. Each double-sided anode sheet was first calendered, after which the coating surface appearance was modified due to the applied load. No transfer or removal of anode coating from the carbon-primed Cu foil occurred during the calendering process. The adhesion of the binder-free anode coating after calendering was sufficiently strong to allow for automated electrode punching and winding of separator. LiB cells were then assembled with the binder-free anodes paired with conventional NMC cathodes with PVdF binder. For performance comparison, LiB cells were also assembled with graphitic anodes containing carboxymethylcellulose/styrene butadiene rubber (CMC/SBR) binder and carbon black conductive additive, and the same NMC cathode with binder.

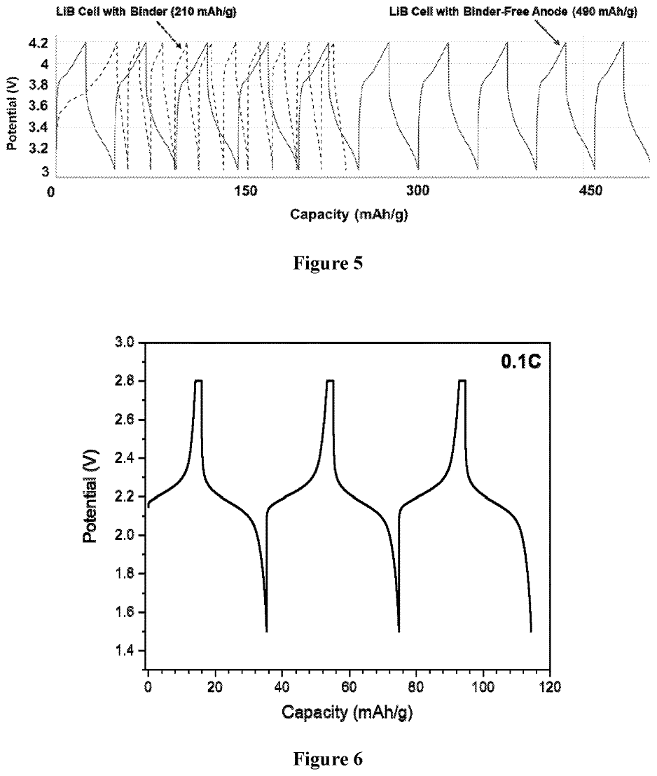

The assembled cells were tested for fast discharge rate performance at 10 C. After charging each cell to 100% capacity at 1 C, the cell was fully discharged in 6 minutes at 10 C. FIG. 5 shows the cumulative 1 C charge-10 C discharge profiles of the binder-free LiB cell type after 10 cycles between 3 V and 4.2 V. For benchmarking, the corresponding high-rate discharge profile for a cell assembled with a conventional NMC111 cathode coupled with a conventional graphitic anode, with polymeric binder in both electrodes, is shown as the dashed profile in FIG. 5.

From the raw charge-discharge profiles, it is seen that after 10 consecutive 1 C charge-10 C discharge cycles, the maximum capacity of ˜490 mAh/g was achieved with the LiB cell containing the binder-free Si-doped anode and standard NMC111 cathode (corresponding to 49 mAh/g in Table 7). For reference, a conventional LiB pouch cell assembled with binder-containing NMC cathode and graphite anode displayed a cumulative capacity of ˜210 mAh/g after testing under the same high discharge rate conditions (corresponding to 20 mAh/g in Table 6).

Table 4 shows the cumulative capacity values after 10 consecutive 1 C charge-10 C discharge cycles after normalizing to each LiB cell's respective mass. Compared to the cell with binder, LiB cells assembled without binder in the Si-doped anodes exhibited higher measured specific capacity for graphitic anodes of 490 mAh/g vs. 210 mAh/g for the cell with binder (normalized capacity values of 49 mAh/g vs. 20 mAh/g). This represents more than 2.3× higher specific capacity compared to the binder-containing NMC|graphite cell. These results show the performance advantage of eliminating the polymeric binder from the battery anodes in high-rate application.

TABLE 4
Cumulative specific capacity at 10 C for LiB cell containing
binder-free Si-doped graphite anode paired with binder-containing
NMC111 cathode, and the performance gain compared to a conventional
cell with both binder-containing electrodes (POR).

| | | Capacity at 20 A | |
|---|---|---|---|
| Anode | Cathode | (mAh/g) | % gain |
| Graphite with binder, and | NMC with binder | 210 | — |
| no SWCNT | | | |
| Si-graphite, binder-free, | NMC with binder | 490 | 133 |
| with high purity SWCNT | | | |

As is typical of LiB cells with anodes containing silicon, the lifetime performance of such cells is compromised due to the extensive volume expansion of the silicon particles upon successive charge-discharge cycles, resulting in fragmentation of the anode active material and cell failure well before 1000 cycles. However, the early cycling performance of cells containing binder-free Si doped graphite anode was superior to that of cells with binder-containing Si doped graphite anode.

10. Binder-Free Lithium Titanate (LTO) Anode Formulations with SWCNT

Binder-free anode formulations were prepared using a commercial high-purity battery grade lithium titanate (LTO, Li₄Ti₅O₁₂) powder (1.5-3 μm; specific surface area: 5-9 m²/g). ICP analysis of this LTO material revealed a molar ratio of Li/Ti of 0.82, which is very close to stoichiometry in Li₄Ti₅O₁₂. SWCNT dispersions were prepared in either IPA or water solvent for formulation with LTO anode active material. In each case, 25 g of high purity SWCNT were mixed into 500 mL of solvent to yield a 50 g/L suspension of SWCNT in solvent, which was then processed by high shear to obtain a dispersion.

60 mL of each prepared SWCNT dispersion, corresponding to 3 g of SWCNT, were combined with 147 g of LTO powder for a mass ratio of 98:2 wt % (LTO:CNT). Each LTO/SWCNT mixture was then combined in a planetary mixer with ˜200 mL of either water or IPA to obtain the anode formulation.

### 11. Binder-Free LTO/SWCNT Anode Coatings

Each LTO/SWCNT anode formulation prepared in Example 10 was coated onto carbon-primed Cu foil via knife-coating. The LTO formulations in either IPA or water wetted and spread evenly across the Cu foil surface. The knife gap setting was 0.55 mm, resulting in a loading of ˜10 mg/cm2 per side of 98% active material. All resulting dried anode coatings were light gray in color, and appeared smooth with no visible presence of coarse agglomerates, fractures, or pinholes.

SEM imaging was performed on the fabricated anode coatings to compare coating quality for the presence or absence of microscopic agglomerates in the coatings, and to visualize the connectivity of the SWCNT across the LTO clusters. In contrast to the morphology of graphitic flakes with basal plane edges, the LTO coatings were composed of micron-sized spherical clusters of active material which in turn were comprised of nano-sized particles. The SEM images revealed extensive infiltration of the SWCNT bundles into each of the LTO clusters, and a high degree of SWCNT connectivity between clusters.

To evaluate coating adhesion and degree of coating flake-off from the Cu current collector, 15 mm×20 mm electrodes were punched from sections of each of the dried binder-free LTO anode coatings. Binder-free LTO coatings fabricated from both IPA and water were sufficiently sturdy to withstand the electrode punching process and yielded intact electrode pieces without signs of coating flake-off or delamination at the edges. This indicates that the dried binder-free LTO anode coatings fabricated by knife-coating of IPA and water-based slurries exhibited satisfactory adhesion to the carbon-primed Cu foil current collector.

12. Binder-Free Carbon-Coated Lithium Titanate (C-LTO) Anode Formulation with SWCNT

Binder-free anode formulations were prepared using a commercial high-purity battery grade lithium titanate (LTO, Li₄Ti₅O₁₂) powder having a graphitic carbon coating (3-5 μm; specific surface area: 16 m²/g). The carbon coating over the LTO particles is intended to improve the electrical conductivity of the insulating LTO material. The carbon-coated LTO anode active material is hereafter referred to as C-LTO.

25 g of high purity SWCNTs were mixed into 500 mL of IPA to yield a 50 g/L suspension. The mixture was processed by high shear treatment to obtain a dispersion. 60 mL of the prepared SWCNT dispersion, corresponding to 3 g of SWCNT, were combined with 147 g of C-LTO powder for a mass ratio of 98:2 wt % (LTO:SWCNT). Both materials were combined in a planetary mixer with ˜200 mL of IPA to obtain the anode formulation.

### 13. Binder-Free C-LTO Anode Coatings

The binder-free C-LTO anode formulation prepared in Example 12 was coated onto carbon-primed Cu foil via knife-coating. The C-LTO formulation spread evenly across the Cu foil surface. The knife gap setting was 0.55 mm, resulting in a loading of 11 mg/cm² per side of 98% active material. Average coating thickness was 80 μm per side. All resulting dried anode coatings appeared smooth with no visible presence of coarse agglomerates, fractures, or pinholes. The adhesion of the binder-free coating to the underlying Cu foil current collector was good, with no delamination or flaking.

SEM imaging was performed on the fabricated binder-free C-LTO anode coatings to compare coating quality for the presence or absence of microscopic agglomerates in the coatings, and to visualize the connectivity of the SWCNT across the C-LTO clusters.

In contrast to the morphology of graphitic flakes with basal plane edges, the C-LTO coatings were composed of micron-sized spherical clusters of active material which in turn were comprised of nano-sized particles. The SEM images showed infiltration of the SWCNT bundles into each of the C-LTO clusters, as well as the high degree of connectivity across clusters.

### 14. LiB Pouch Cell Containing Binder-Free C-LTO Anode

C-LTO anode sheets prepared as in Example 13 were assembled into LiB pouch cells. Each double-sided C-LTO anode sheet was first calendered. No transfer or removal of coating from the carbon-primed Cu foil current collector were observed. Adhesion of the binder-free C-LTO anode coating after calendering was sufficiently strong to allow for automated electrode punching and winding of separator. The binder-free C-LTO anodes were paired with standard commercial NMC cathodes (with binder), with tabs welded to both electrodes and enveloped with separator.

For performance comparison, LiB cells were also assembled with C-LTO anodes containing polyvinylidene fluoride (PVdF) binder and carbon black (CB) conductive additive formulated in a ratio of 90:5:5 (C-LTO:PVdF:CB). The binder-containing C-LTO anode was paired with NMC 111 cathode containing binder.

FIG. 6 shows the formation cycles at 0.1 C of the LiB pouch cell containing binder-free C-LTO anode. The voltage range of operation was 1.5 V to 2.8 V. The cell displayed regular charge and discharge electrochemical cycles. The calculated discharge capacity of the NMC|C-LTO (binder-free) cell was 20 mAh/g, corresponding to a rated cell capacity of 1.5 Ah.

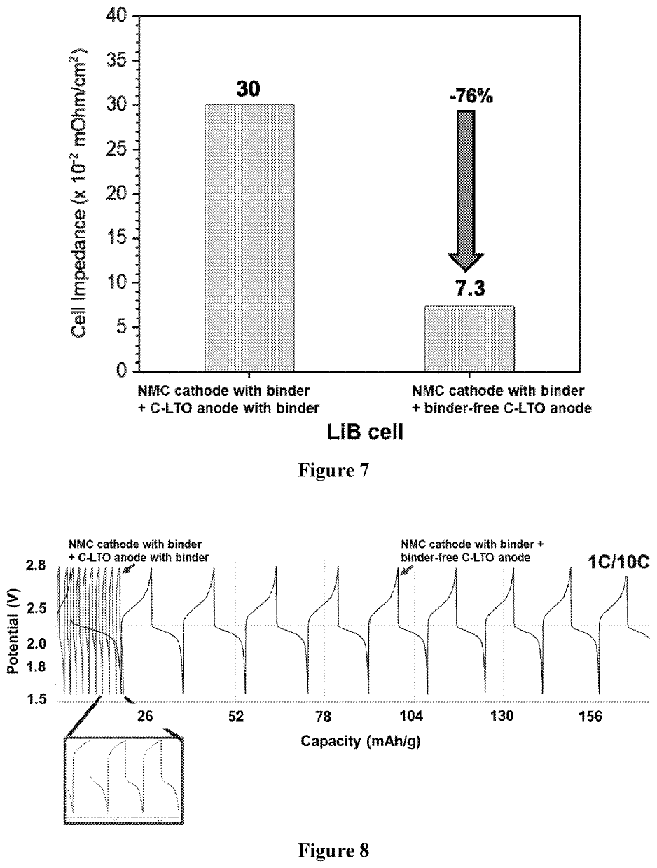

After the cell formation process, the assembled binder free C-LTO|NMC and C-LTO with binder/NMC cells were measured for initial DC cell impedance. FIG. 7 compares the average measured cell impedances of three LiB pouch cells assembled with binder, and three cells with binder-free C-LTO anode. The cells with binder-free C-LTO anode exhibited an average impedance of 7.3×10⁻² mΩ/cm², or a 76% reduction in impedance compared to the cell with binder (30×10⁻² mΩ/cm²). This markedly reduced cell impedance of the binder-free C-LTO anode occurs despite having 8% higher C-LTO content than the cell with binder.

The cells containing C-LTO anodes were measured for discharge capacity at 1 C rate (after 1 C charge) over the operational voltage range of 1.5 V to 2.8 V. The assembled cells with binder-free C-LTO anodes exhibited an average discharge capacity of 20 mAh/g, an 18% increase in capacity compared to the cell with binder (17 mAh/g). This higher initial capacity in the binder-free C-LTO cells is due to the 8% higher C-LTO active material content than the cell with binder.

### 15. High-Rate Capacity Performance of Binder-Free Lithium-Ion Battery Cells

LiB pouch cells containing binder-free C-LTO anode paired with conventional binder-containing NMC111 cathodes, prepared as in Example 14, were tested for fast discharge rate performance at 10 C. After charging each cell to 100% capacity at 1 C, the cell was fully discharged in 6 minutes at 10 C. FIG. 8 shows the cumulative 1 C charge-10 C discharge profiles of the binder-free LiB cell type after 10 cycles between 3 V and 4.2 V. For benchmarking, the corresponding high-rate discharge profile for a cell with polymeric binder in both electrodes is shown as the dashed profile. After 10 consecutive 1 C charge-10 C discharge cycles, a huge disparity appeared between cumulative capacities of the binder-free C-LTO cell and the C-LTO cell with binder. The cumulative capacity of 170 mAh/g after 10 cycles at 10 C rate was achieved with the LiB cell containing the binder-free C-LTO anode (corresponding to 17 mAh/g in Table 9), compared to only 19 mAh/g for the C-LTO cell with binder under the same test conditions (corresponding to 2 mAh/g in Table 9).

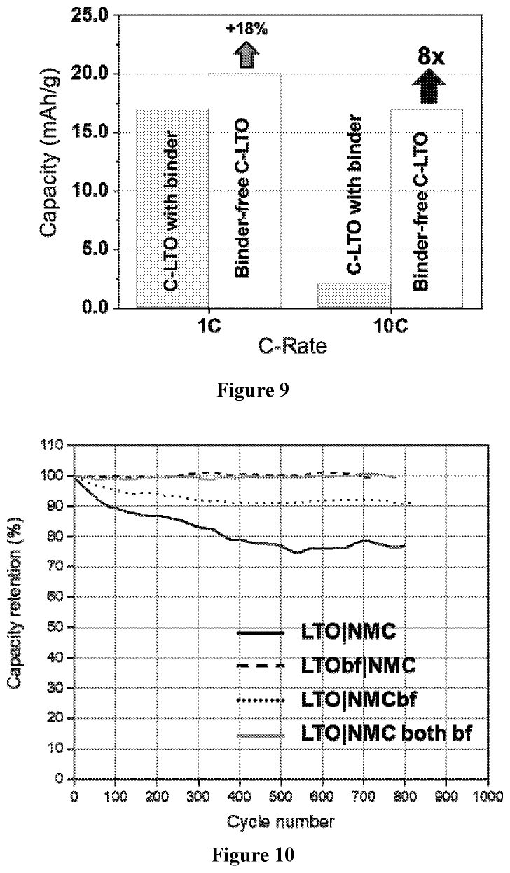

FIG. 9 compares the cell capacities at the two C-rates normalized to the respective average cell masses. The binder-free C-LTO cell showed normalized capacity of 17 mAh/g at 10 C rate vs. 2 mAh/g for the C-LTO cell with binder. The performance advantage of the cells with binder-free C-LTO anode (8× higher capacity at 1° C. rate) in high-rate applications was clearly shown.

Table 5 shows the respective rated capacities of cells with both C-LTO types at 1 C charge and 10 C fast charge. Compared to the C-LTO cell with binder, LiB cells assembled with binder-free C-LTO exhibited higher rated capacity at both investigated C-rates. The cell capacity advantage with the binder-free C-LTO cell is maximized at 1° C. rate with 9× higher capacity of 17 mAh/g vs. 2 mAh/g for the C-LTO cell with binder. This translates to only 15% capacity loss at high 10 C rate for the binder-free C-LTO cell compared to near 90% capacity loss for the C-LTO cell with binder.

TABLE 5
Rated cell capacities at 1 C and 10 C (fast charge)
rates of LiB cells containing binder-free C-LTO and
C-LTO anodes with binder paired with binder-containing
NMC111 cathodes and the respective capacity loss.

| | Capacity (mAh/g) | | |
|---|---|---|---|
| Cell | 1 C | 10 C | % loss |
| NMC\|C-LTO with binder and | 17 | 2 | 89 |
| no SWCNT | | | |
| NMC\|C-LTO binder-free, with | 20 | 17 | 15 |
| 2% high purity SWCNT | | | |

### 16. Summary of LiB Performance Characteristics Using Different Anode Chemistries

The following Tables 6-9 summarize the performance characteristics of LiB cells having different anode chemistries. Four different anode active materials are represented: Graphite, Si-Graphite, LTO, and C-LTO. The cathode material in all cases was NMC111. For each anode material, capacity values were determined for cells in which the cathode contained binder or was binder-free, and for cells in which the anode contained binder or was binder-free. Cells with binder in the anode are comparative samples, whereas cells with binder-free anode are examples of the present invention. All permutations of presence/absence of binder in both cathode and anode were assembled and measured. Capacity was measured at both 1 C and 10 C discharge rate for all cells.

TABLE 6A
Nominal capacity values (1 C and 10 C) of LiB cells with NMC111
cathode and Graphite anode. Binder-free cathode and binder-free
anode both contain 2% high purity SWCNT. Binder-containing cathode
and binder-containing anode both contain no (0%) SWCNT.

| | Cathode: | | Anode: | | | | |
|---|---|---|---|---|---|---|---|
| | NMC111 | | Graphite | | | | |
| | Binder | | Binder | | | | Capacity |
| | Yes | No | Yes | No | Rate | | (mAh/g) |
| Comparative | X | | X | | 1 | C | 49 |
| Invention | X | | | X | | | 51 |
| Comparative | | X | X | | 1 | C | 52 |
| Invention | | X | | X | | | 55 |
| Comparative | X | | X | | 10 | C | 20 |
| Invention | X | | | X | | | 40 |
| Comparative | | X | X | | 10 | C | 41 |
| Invention | | X | | X | | | 43 |

TABLE 6B
Nominal capacity values (10 C) of LiB cells with binder-containing
NMC111 cathode (containing no SWCNT) and binder-free Graphite
anode containing as-received vs. high-purity SWCNT.

| | | | | | Capacity |
|---|---|---|---|---|---|
| | Cathode | Anode | SWCNT type | Rate | (mAh/g) |
| Comparative | NMC with | Graphite | As-received | 10 C | 35 |
| | Binder | No Binder | (10.5% Fe) | | |
| Invention | NMC with | Graphite | High-purity | 10 C | 43 |
| | Binder | No Binder | (<1% Fe) | | |

In Tables 7-9 below, Binder-free cathode and binder-free anode both contain 2% high purity SWCNT. Binder-containing cathode and binder-containing anode both contain no (00%) SWCNT.

TABLE 7
Nominal capacities (1 C and 10 C) of LiB cells
with NMC111 cathode and Si-Graphite anode.

| | Cathode: | | Anode: | | | | |
|---|---|---|---|---|---|---|---|
| | NMC111 | | Si-Graphite | | | | |
| | Binder | | Binder | | | | Capacity |
| | Yes | No | Yes | No | Rate | | (mAh/g) |
| Comparative | X | | X | | 1 | C | 54 |
| Invention | X | | | X | | | 56 |
| Comparative | | X | X | | 1 | C | 57 |
| Invention | | X | | X | | | 60 |
| Comparative | X | | X | | 10 | C | 25 |
| Invention | X | | | X | | | 49 |
| Comparative | | X | X | | 10 | C | 51 |

| | | | |
|---|---|---|---|
| Invention | X | X | 54 |

TABLE 8
Nominal capacities (1 C and 10 C) of LiB
cells with NMC111 cathode and LTO anode.

| | Cathode: | | | | | | |
|---|---|---|---|---|---|---|---|
| | NMC111 | | Anode: LTO | | | | |
| | Binder | | Binder | | | | Capacity |
| | Yes | No | Yes | No | Rate | | (mAh/g) |
| Comparative | X | | X | | 1 | C | 13 |
| Invention | X | | | X | | | 19 |
| Comparative | | X | X | | 1 | C | 17 |
| Invention | | X | | X | | | 22 |
| Comparative | X | | X | | 10 | C | 1 |
| Invention | X | | | X | | | 16 |
| Comparative | | X | X | | 10 | C | 15 |

| | | | |
|---|---|---|---|
| Invention | X | X | 20 |

TABLE 9
Nominal capacities (1 C and 10 C) of LiB cells
with NMC111 cathode and C-LTO anode.

| | Cathode: | | Anode: | | | | |
|---|---|---|---|---|---|---|---|
| | NMC111 | | C-LTO | | | | |
| | Binder | | Binder | | | | Capacity |
| | Yes | No | Yes | No | Rate | | (mAh/g) |
| Comparative | X | | X | | 1 | C | 17 |
| Invention | X | | | X | | | 20 |
| Comparative | | X | X | | 1 | C | 18 |
| Invention | | X | | X | | | 22 |
| Comparative | X | | X | | 10 | C | 2 |
| Invention | X | | | X | | | 17 |
| Comparative | | X | X | | 10 | C | 15 |

| | | | |
|---|---|---|---|
| Invention | X | X | 20 |

As shown in Tables 6-9, in each and every case, the cell with binder-free anode (Invention) showed superior performance in capacity at 1 C and 10 C, compared with the corresponding cell having binder in the anode (Comparative).

All superior capacity values of cells with binder-free and 2% high purity SWCNT anode are considered significant at the cell level in the battery field. These data demonstrate the superior performance of LiB cells in a binder-free and 2% high purity SWCNT anode configuration, compared with cells having the same chemistry but with binder and no SWCNT in the anode.

Furthermore, Table 6B shows that in cells having the same configuration of binder-containing NMC cathode and binder-free graphite anode with SWCNT, the use of high-purity SWCNT (<1% Fe) in the anode provides substantially improved performance over as-received, lower-purity SWCNT (10.5% Fe). Specifically, capacity at 10 C charge/discharge rate increased by ˜23% when high-purity SWCNT was used compared with the lower-purity SWCNT.

### 17. Lifetime Cycling Performance of Binder-Free Lithium-Ion Battery Cells

LiB cells were assembled from combinations of LTO anodes (with and without binder) and NMC cathodes (with and without binder) according to the cell matrix shown in Table 10.

TABLE 10
Assembled LiB cell matrix showing various combinations of
LTO anode and NMC cathode, with and without binder. “bf” =
binder-free. Binder-free cathode and binder-free anode
both contain 2% high purity SWCNT. Binder-containing cathode
and binder-containing anode both contain no (0%) SWCNT.

| LiB cell | Anode | Cathode |
|---|---|---|
| LTO \| NMC | LTO with binder | NMC with binder |
| LTObf \| NMC | LTO binder-free | NMC with binder |
| LTO \| NMCbf | LTO with binder | NMC binder-free |
| LTO \| NMC both bf | LTO binder-free | NMC binder-free |

Four cell types were assembled as shown in Table 10 for lifetime cycing performance evaluation. The lifetime test involves consecutive charge-discharge cycles at 25° C. over the voltage range of 1.5 V-2.8 V, using constant current (CC) process at a rate of 0.5 C, with no rest period between charge and discharge steps. The comparative capacity retention profiles upon cycling the four LiB cell types are shown in FIG. 10.

The LiB cell with conventional LTO anode and NMC cathode, both with binder and no SWCNT in these electrodes, shows steepest capacity fade with capacity retention of <80% after cycling for more than 400 cycles. The cycling performance enhancement of LiB cells with at least one binder-free (bf) electrode and 2% high purity SWCNT is clearly evident. After 700 cycles, LiB cells with either binder-free and high purity SWCNT anode or cathode retain >90% of initial capacity. The most advantageous performance however is observed for LiB cells assembled with binder-free LTO anode. These two cell types, designated as “LTObf|NMC” and “LTO|NMC both bf”, both show close to 100% capacity retention after 700 cycles, indicating superior lifetime cycling performance of LiB cells achieved with the use of binder-free LTO anodes.

Although several embodiments of the invention have been described in the Examples given above, those of ordinary skill in the art will appreciate that various modifications can be made without departing from the scope of the invention. Accordingly, other embodiments are within the scope of the following claims.

What is claimed:

1. A lithium-ion battery (LiB), having an anode electrode comprising:
90-99 wt % of an active material, and
1-5 wt % of single wall carbon nanotubes (SWCNT), wherein the SWCNT has an inorganic impurity content of less than 10 wt %,
wherein the anode electrode is essentially free of any polymeric binding material.

2. The LiB of claim 1, wherein the SWCNT has an inorganic impurity content of less than 3 wt %.

3. The LiB of claim 2, wherein the inorganic impurities comprise Fe, Ni, Al, Si, Cl, or any combination thereof.

4. The LiB of claim 1, wherein the SWCNT has a BET specific surface area between about 400 and about 1300 m²/g.

5. The LiB of claim 1, wherein the SWCNT has a Raman G/D integrated peak area ratio of at least 20 as measured using a laser having a 532 nm wavelength.

6. The LiB of claim 1, wherein the active material of the anode electrode is selected from the group consisting of: graphite, Si-doped graphite, Si alloy, Si particles in the form of nano- or micro-particles, lithium titanate (LTO), niobium-doped LTO, and any combination thereof.

7. The LiB of claim 1, further comprising a binder-free cathode electrode.

8. The LiB of claim 7, wherein the binder-free cathode comprises an active material Li—NiMnCo-Oxide (Li-NMC).

9. The LiB of claim 6, further comprising a cathode comprising an active material of Li-NMC, and the anode electrode comprises an active material of graphite.

10. The LiB of claim 9, wherein the cathode further comprises 1-5 wt % of SWCNT having an inorganic impurity content of less than 10 wt %, and the cathode is essentially free of any polymeric binding material.

11. The LiB of claim 6, further comprising a cathode comprising an active material of Li-NMC, and the anode electrode comprises an active material of silicon-doped graphite.

12. The LiB of claim 6, further comprising a cathode comprising an active material of Li-NMC, and the anode electrode comprises an active material of carbon-coated lithium titanate.

13. The LiB of claim 6, further comprising a cathode comprising an active material of Li-NMC, and the anode electrode comprises an active material of LTO.

14. The LiB of claim 6, wherein the amount of silicon in the anode is between 10 and 40 wt %.

15. The LiB of claim 6, wherein the LTO has a composition of Li₄₊ₓTi₅O₁₂, where x is 0 to 3, and the LTO is in a form of a spinel crystal structure or rock salt crystal structure.

16. The LiB of claim 15, wherein the LTO is in the form of nanoparticles and has a carbon coating (C-LTO).

17. The LiB of claim 1, wherein the anode electrode further comprises a copper current collector.

18. The LiB of claim 17, wherein the copper current collector comprises copper foil and a carbon primer layer deposited onto the copper foil, or the copper current collector comprises corona plasma discharge-treated copper foil.

19. The LiB of claim 1, wherein the anode electrode further comprises an aluminum current collector.

20. The LiB of claim 19, wherein the aluminum current collector comprises aluminum foil and a carbon primer layer deposited onto the aluminum foil, or the aluminum current collector comprises corona plasma discharge-treated aluminum foil.

21. The LiB of claim 1, wherein the polymeric binding material is polyvinylidene fluoride (PVdF).

22. A method of preparing an anode for a LiB, comprising the steps of:
(a) providing a SWCNT dispersion, wherein the SWCNTs have an inorganic impurity content of less than 10 wt %, and the SWCNT dispersion does not contain a surfactant or a binder;
(b) combining the SWCNT dispersion with an anode active material in a prescribed ratio to form a homogeneous mixture,
(c) coating the homogeneous mixture onto a metallic current collector,
(d) drying the homogeneous mixture to form an anode comprising a uniform coating on the metallic current collector, and
(e) calendering the anode.

23. The method of claim 22, wherein the SWCNT dispersion is formed by:
(i) mechanically mixing SWCNT with an organic solvent, an aqueous-based solution, or a mixture thereof, to form a SWCNT suspension, and
(ii) applying shear to the SWCNT suspension at a shear rate of at least 800,000 s⁻¹.
